(19) United States
(12) Patent Application Publication
(10) Pub. No.: US 2014/0211788 A1
(43) Pub. Date: Jul. 31, 2014

(54) METHOD AND A SYSTEM TO DISCOVER AND ESTABLISH AN ENRICHED COMMUNICATION CHANNEL IN A VOICE CALL

(71) Applicants: Gustavo Garcia, Madrid (ES); Álvaro Martínez, Madrid (ES)

(72) Inventors: Gustavo Garcia, Madrid (ES); Álvaro Martínez, Madrid (ES)

(73) Assignee: TELEFONICA, S.A., Madrid (ES)

(21) Appl. No.: 14/130,863

(22) PCT Filed: Jun. 27, 2012
(86) PCT No.: PCT/EP2012/062459

§ 371 Date: Apr. 3, 2014

(30) Foreign Application Priority Data
Jul. 6, 2011 (ES) P 201131145

(51) Int. Cl. H04M 7/00

(52) U.S. Cl. CPC H04M 7/0057
USPC 370/352

(57) ABSTRACT

A method and a system to discover and establish an enriched communication channel in a voice call.

In the method of the invention said voice call is performed between at least a first user and a second user via their telephone devices, and it comprises discovering if said first and second users are supplied with smart devices provided with hardware, software and/or connectivity capabilities and establishing said enriched communication channel between said smart devices.

The system is arranged for implementing the method of the present invention.

### FIELD OF THE ART

The present invention generally relates, in a first aspect, to a method to discover and establish an enriched communication channel in a voice call, comprising performing said voice call between at least a first user and a second user via their telephone devices and more particularly to a method that further comprises discovering if said first and second users are supplied with smart devices provided with hardware, software and/or connectivity capabilities and establishing said enriched communication channel between said smart devices.

A second aspect of the invention relates to a system arranged for implementing the method of the first aspect.

### PRIOR STATE OF THE ART

Nowadays there are a lot of telephony tools available for end-users with smart devices (PCs and smartphones) and IP connectivity to support the establishment of voice calls with other users. Most of these tools allow maintaining other types of communication like messaging or file, whiteboard and application sharing, in addition and simultaneously to the voice channel. The devices with these software and connectivity capabilities will be referred as smart devices in the next paragraphs.

On the other side there are traditional telephony devices (fixed and mobile devices) offering the voice call services over traditional circuit switched networks. This group of devices will be referred as traditional telephony devices in the next paragraphs.

In traditional telephony devices it is impossible to offer a similar functionality and user experience during the voice calls, due to software and connectivity limitations.

However, during some of these traditional calls, users involved in the call may have access simultaneously to other smart devices. This scenario, with end-users having simultaneous access to both types of devices (traditional telephony and smart devices) is not taken into account when establishing communication between these users.

There are solutions providing related features, but they require the use of smart devices. This is the case of proprietary Apple Facetime technology, standard IMS combinational services [1] or disaggregated media in SIP [2]. Both of them require specific software and IP connectivity in the end-user devices to initiate richer communication channels during or after a voice call.

There are not known methods to discover the smart devices associated to the users involved in a telephone call, and as a consequence there aren't methods to establish automatically or semiautomatically rich sessions during that call.

Traditional telephony devices cannot offer advanced communication capabilities (messaging or file and applications sharing features). Users can establish other communication channels using their smart devices, even at the same time they have an ongoing traditional voice call, but it is not possible to trigger automatically those richer communication channels when establishing the initial traditional voice call.

This limitation is mostly consequence of the technical problem of discovering the smart devices of the user and establishing a communication channel with those devices.

### DESCRIPTION OF THE INVENTION

It is necessary to offer an alternative to the state of the art which covers the gaps found therein, particularly related to the lack of proposals which allow establishing an enriched communication during a traditional telephone call.

To that end, the present invention provides, in a first aspect, a method to discover and establish an enriched communication channel in a voice call, comprising performing said voice call between at least a first user and a second user via their telephone devices.

On contrary to the known proposals, the method of the invention, in a characteristic manner, further comprises discovering if said first and second users are supplied with smart devices provided with hardware, software and/or connectivity capabilities and establishing said enriched communication channel between said smart devices.

Other embodiments of the method of the first aspect of the invention are described according to appended claims 2 to 8, and in a subsequent section related to the detailed description of several embodiments.

A second aspect of the invention concerns to a system to discover and establish an enriched communication channel in a voice call, wherein said voice call is supported by a telephony network and performed between at least a first user and a second user via their telephone devices

The system of the second aspect of the invention, on contrary to the known systems mentioned in the prior state of the art section, and in a characteristic manner, it comprises an external entity to perform said discovery in order to determine if said first and second users are supplied with smart devices provided with hardware, software and/or connectivity capabilities and a communication platform to establish said enriched communication channel between said smart devices.

The system of the second aspect of the invention is adapted to implement the method of the first aspect.

Other embodiments of the system of the second aspect of the invention are described according to appended claims 9 to 11, and in a subsequent section related to the detailed description of several embodiments.

### BRIEF DESCRIPTION OF THE DRAWINGS

The previous and other advantages and features will be more fully understood from the following detailed description of embodiments, with reference to the attached drawings (some of which have already been described in the Prior State of the Art section), which must be considered in an illustrative and non-limiting manner, in which:

FIG. 1 shows the interaction flow between the different elements required to implement the proposed method in this document, according to an embodiment of the present invention.

FIG. 2 shows a possible implementation of the system proposed in this document, according to an embodiment of the present invention.

### DETAILED DESCRIPTION OF SEVERAL EMBODIMENTS

The proposed solution provides the means to automatically initiate a richer communication channel in parallel with traditional voice calls initiated from and to any telephony device without specific hardware, software or connectivity requirements. These parallel communication channels will be established with other smart devices owned by the users involved in the traditional voice call.

The concept includes a system composed of a combination of network elements detecting voice call establishment, and offering to the call participants an additional richer communication channel to be used from their smart devices simultaneously. These offers will be sent to the smart devices of the users based on other identities pre-configured by each participant in the call.

The proposed system is based on the use of existing protocols and available procedures. This way, it is possible to easily provide (without new requirements) the access to these enriched voice calls from any combination of smart and traditional devices by combining these protocols and procedures in an innovative way.

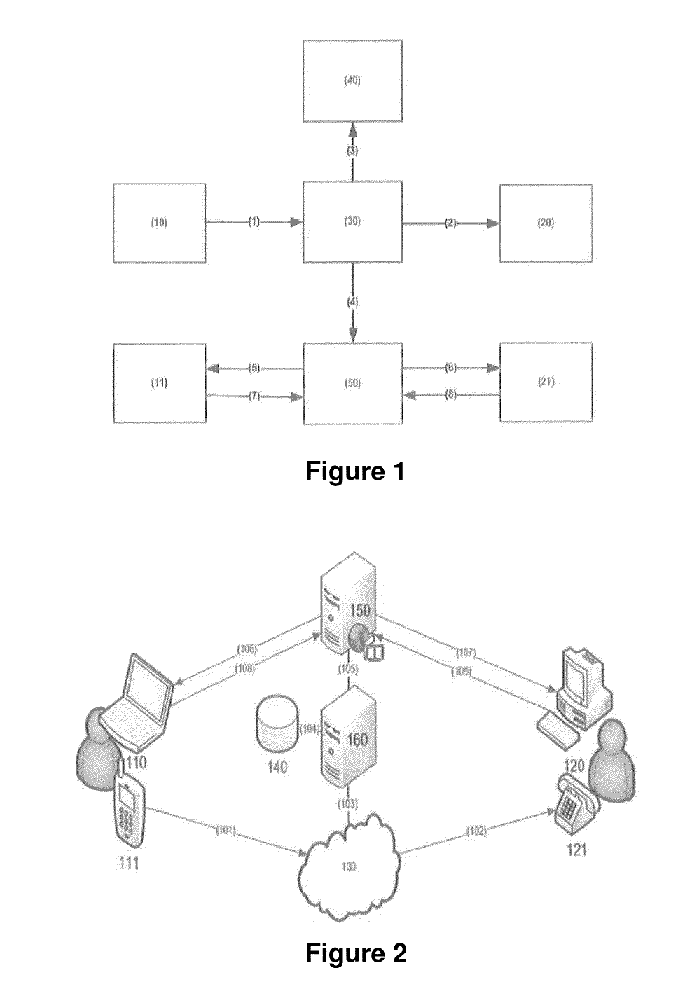

The elements involved in this invention, as shown in FIG. 1, are: the traditional terminal of the user initiating the call (10), the smart device of the user initiating the call (11), the traditional terminal of the user receiving the call (20), the smart device of the user receiving the call (21), the telephony network routing the call (30), the external service providing the identity mapping of the users (40) and the platform providing rich communication capabilities (50).

First of all, the present invention assumes that there is a service providing the mapping between the traditional telephony identifiers (E.164 numbers) and other user identifiers being used in the smart devices for communications over the Internet (typically email addresses). That service could be populated with the information preconfigured manually by the users to be allowed to access to this enriched calls feature or it could be used an existing external service including profiles of users (for example online agendas, social networks, vcards, DNS ENUM tree . . . ).

The first step involved in the process is the initiation of a traditional voice call. In this step, the caller device (10) sends the required signaling message (1) to establish a regular circuit-switched phone call. The telephony network (30) receives that request and routes the call as any other call in the network sending the signaling message (2) to the called device (20). This is the regular initiation and establishment of a traditional voice call.

When receiving the call in the telephony network (30), and additionally to the call routing, the network will try to obtain other different identifiers for the caller and the called parties. To this purpose, one or more external mapping services (40) will be queried based on the E.164 identifiers of the parties known at this point. This mapping process can be iterative and recursive, using the new identifiers obtained as an input for new mapping requests.

If the mapping process succeed obtaining both users new identifiers for communication over smart devices (for example an email address or a messaging application user identifier) the network will send a request (4) to the rich communications platform (50) to initiate the rich communication session with those discovered identities.

The rich communications platform (50) sends then a notification (5)(6) to those identities including call information and instructions to proceed with the establishment of the richer parallel communication channel (7)(8) using the application which provides those capabilities (50). When possible, the platform will trigger directly the establishment of that richer communication channel instead of just sending a notification requiring a manual action from the users. The availability of this automatic establishment will vary depending on the available identifiers discovered, making possible the automatic establishment if these identifiers correspond to a rich communication service (for example a messaging application user identifier).

The mapping process could also be performed by the rich communications platform (50), a node in the telephony network (30) or any other dedicated element in the network or end user devices.

The notification sent could include additional information of the other participant (photo, profile, status . . . ) obtained from external sources, and/or could include information of the call (origin, destination, date) in plain text or any standardized format to be manually or automatically processed by other systems like typical calendaring software.

This system could be extended to more than two participants in case of three-way calls or voice conferences with multiple participants.

A typical implementation of this system, as shown in FIG. 2, could include a web interface where the users configure their identities and a database where this information is stored to be retrieved later by the network elements processing the incoming calls. That interface is out of the scope of this invention; only the database (140) to be requested is included in the description of this concrete implementation. It is assumed for the rest of the implementation description that both users involved in the scenario have configured an email addresses associated to their phone numbers.

In this typical implementation a user starts a call with a traditional phone device (111) and that call is received by the circuit switched telephone network infrastructure (130), which will progress the call to the destination phone device (121).

In addition to routing the call, the telephony network triggers the execution of the business logic in an intelligent node (160) sending a notification (103) including the information of the participants of the call. That notification must include at least the telephone number of the caller and called parties and usually will be sent using standard IN signalling based on SS7 protocol stack.

The intelligent node (160) checks in the database (140) if both users (caller and called) have an email address associated. If those email addresses can be retrieved, the intelligent node requests to a platform providing rich communication capabilities (150) to send a notification to those users including the information required to establish a bidirectional rich-communication session. That request (105) is an internal interface of the system and can be base in any proprietary protocol although typically is implemented on top of HTTP.

That platform (150) composes an email including information about the call (caller and called party) and also a URL with a unique identifier to a shared workspace in the platform (150). Both users will receive these emails through their usual email applications in the smart devices (110 and 120), so that they can access manually and individually to the included URL to make use of the shared workspace capabilities.

Instead of sending an email with the URL, other identities and communication channels can be used. For example an IM user identifier and IM message with the URL on top of any IM network and protocol (for example SIP or XMPP) is other possible realization of this step of the invention (106-107).

Other possible realization of the establishment of the rich session (106-107) is to make use of an ad-hoc application installed in the smart devices (110 and 120). The platform (150) keeps a connection with those applications and sends a message using any messaging protocol like SIP or XMPP. When the application receives the message it can automatically open the rich session interface providing a completely automatic rich session establishment.

The session establishment (108-109) is typically based on an HTTP request to open a web interface but could be based on any protocol and interface supported in the smart devices involved in the session (110-120). For example, instead of receiving a HTTP URL and open a web interface, the smart device could receive a SIP URI and open a videoconference when that URI is clicked.

From a user perspective, the use case of this invention is related to being able to share files or draw collaboratively in the computer after establishing a regular call with the mobile device. Users' computer would receive automatically an invitation to create the richer session and the user would be speaking at the phone with the other party and for example drawing in the computer screen at the same time.

### Advantages of the Invention

For the service providers, the main benefit offered by these richer calls service is the improvement of user experience and functionality of the traditional voice call service, which could increase the voice traffic in their networks.

The advantage of this solution over existing solutions based on smart devices is the applicability to traditional telephone devices including even fixed plain old telephones without display and any interaction capabilities.

One of the technical advantages of the solution described in the invention is the complete execution in the network side avoiding the necessity of additional software in the devices. In addition the solution doesn't require any change in the network core and can be implemented on top of existing standard IN capabilities.

The other technical advantage is the possibility to be used with any kind of smart devices identifiers and channels, from email address to IM user identifiers.

A person skilled in the art could introduce changes and modifications in the embodiments described without departing from the scope of the invention as it is defined in the attached claims.

### ACRONYMS

IP Internet Protocol
URL Universal Resource Locator
URI Universal Resource Identifier
IMS IP Multimedia Subsystem
SIP Session Initiation Protocol
XMPP Extensible Messaging and Presence Protocol
HTTP Hypertext Transfer Protocol
DNS Domain Name System
ENUM E.164 Numbers and DNS
IN Intelligent Network
IM Instant Messaging
SS7 Signalling System #7

### REFERENCES

“Combined Circuit Switched (CS) and IP Multimedia Subsystem (IMS) sessions; Stage 1”. 3GPP TS 22.279. version 9.0.0. December 2009.
[2] “Disaggregated Media in the Session Initiation Protocol (SIP)”. IETF draft. G.Camarillo, S. Loreto. February 2010.

1-12. (canceled)

13. A method to discover and establish an enriched communication channel in a voice call, comprising performing said voice call between at least a first user and a second user equipped with telephone devices via a circuit switched network, the method further comprises during at least the establishment of said voice call:
discovering if said first and second users have access to smart devices provided with hardware, software and/or connectivity capabilities, said discovering being performed by mapping a connection identifier used by said smart devices when using said hardware, software and/or connectivity capabilities; and
establishing said enriched communication channel between said smart devices in parallel to said voice call.

14. A method as per claim 13, comprising establishing, at each voice call, said enriched communication channel semiautomatically by requesting a confirmation of said first and second users or automatically with no intervention per part of said first and second users.

15. A method as per claim 13, wherein said connection identifier being preconfigured by said first and second users with traditional telephony identifiers of said telephone devices.

16. A method as per claim 15, wherein said connection identifier is the email address or an Instant Messaging identifier and said traditional telephony identifiers are E.164 numbers.

17. A method as per claim 14, comprising sending a notification to said smart devices after said discovery in order to request a confirmation of said first and second users, when performing a semiautomatic establishment.

18. A method as per claim 17, wherein said notification includes information of said first and second users and/or information of said voice call.

19. A method as per claim 13, comprising using said enriched communication channel to make use of at least one of the following shared capabilities: messaging, file sharing, whiteboard sharing or application sharing between said first and second users.

20. A method as per claim 19, wherein said notification is an email containing an URL to a workspace containing said share capabilities.

21. A system to discover and establish an enriched communication channel in a voice call, wherein said voice call is performed between at least a first user and a second user equipped with telephone devices via a circuit switched network, characterised in that it comprises:
an external entity to perform said discovery in order to determine if said first and second users have access to smart devices provided with hardware, software and/or connectivity capabilities; and
a communication platform to establish said enriched communication channel between said smart devices in parallel to said voice call.

22. A system as per claim 21, wherein said external entity performs a mapping process between a connection identifier used by said smart devices when using said hardware, software and/or connectivity capabilities, said connection identifier being preconfigured by said first and second users, and traditional telephony identifiers of said telephone devices.

23. A system as per claim 21, wherein said circuit switched network sends a request to said communication platform in order to perform said establishment of said enriched communication channel if said mapping process is successful.

24. A system as per claim 21, wherein said communication platform establishes said enriched communication channel semiautomatically by sending a confirmation request to said first and second users or automatically with no intervention per part of said first and second users.
